(19) United States
(12) Patent Application Publication
(10) Pub. No.: US 2018/0370101 A1
(43) Pub. Date: Dec. 27, 2018

(54) INJECTION MOLDING MACHINE WITH SECOND INJECTION UNIT

(71) Applicant: ATHENA AUTOMATION LTD., Vaughan (CA)

(72) Inventors: Robert D. Schad, Toronto (CA); Stephen Mracek, Oakville (CA); Patrick Roessler, Oakville (CA)

(73) Assignee: ATHENA AUTOMATION LTD., Vaughan (CA)

(21) Appl. No.: 16/116,314

(22) Filed: Aug. 29, 2018

Related U.S. Application Data
(63) Continuation of application No. PCT/CA2017/050289, filed on Mar. 3, 2017.
(60) Provisional application No. 62/302,930, filed on Mar. 3, 2016.

(51) Int. Cl. B29C 45/17; B29C 45/22; B29C 45/62

(52) U.S. Cl. CPC B29C 45/1744; B29C 2045/238; B29C 45/62; B29C 45/22

(57) ABSTRACT

An injection molding machine includes a machine base extending lengthwise along a machine axis. The base has a platen support portion extending along a first axial portion of the base, and an injection unit support portion extending along a second axial portion of the base. The machine further includes a platen supported by the platen support portion for carrying a mold half apparatus. The machine further includes a first injection unit supported by the injection unit support portion for discharging a first melt through the platen into a first mold inlet of the mold half apparatus, and a second injection unit supported by the injection unit support portion for discharging a second melt around the platen into a second mold inlet of the mold half apparatus.

This application is a continuation of PCT Patent Application Serial No. PCT/CA2017/050289, filed Mar. 3, 2017, which claims the benefit of Provisional Application Ser. No. 62/302,930, filed Mar. 3, 2016, both of which are hereby incorporated herein by reference.

### FIELD

The specification relates to injection molding machines, elements thereof, and methods and apparatuses for injecting mold material into a mold half apparatus.

### BACKGROUND

U.S. Pat. No. 5,700,500 (Wilhelm) relates to a two-stage injection-molding machine with a fixed mold plate, a movable mold plate and a two-part intermediate assembly, arranged to be movable between said plates, and with a supply of injection-molding material for the intermediate assembly to supply the stages formed between the intermediate assembly and the mold plates with injection-molding material. In order to simplify the production of injection-molded parts of different colors in one and the same injection-molding process it is proposed, in accordance with the invention, that for each stage there has been provided a separate supply of injection-molding material via a separate main channel. In addition to the free choice of the color for each stage, it is possible to use various types of plastic per stage in one and the same injection-molding process.

U.S. Pat. No. 4,589,839 (Kurumaji et al.) discloses an injection molding machine in which molten resin from an extruder is injected into the cavity of a mold through a nozzle. A runner body disposed between the mold and the extruder has a substantially L-shaped hot runner for supplying the molten resin from the extruder to the mold therethrough. The runner body is pivotably supported by a support assembly and is horizontally slidable relative to the support assembly to accommodate thermal expansion, whereby the nozzle mounted on the runner body can be brought into or out of intimate contact with the mold. To accommodate the thermal expansion of the runner body only toward the extruder, a stopper is provided on the base frame.

U.S. Pat. No. 7,232,538 (Mai) discloses an injection molding coupling apparatus and method configured to be installed between a relatively movable injection unit and a relatively stationary unit base. A subplate is configured to be relatively movable with respect to the unit base, and preferably includes linear bearings for rolling on a pair of linear rails. A flexible pad device is configured to be disposed between the subplate and the injection unit. The flexible pad device is configured to minimize misalignment caused by thermal elongation of heated components and the relative movement between the injection unit and the unit base.

U.S. Pat. No. 5,007,822 (Hara et al.) discloses an injection molding machine in which a plurality of stationary molds are securely disposed in a row on a stationary platen and transversely extending parallel to one another, and a moving mold to be coupled with the stationary molds is supported as a unit displaceable in a lateral direction in a mold holder with regard to a moving platen, by coupling and clamping the moving mold and one of a plurality of stationary molds together, injection molding is accomplished, thus by changing stationary molds one after another and clamping the moving mold, the injection molding is accomplished to obtain multi-colored or multi-material molded products. The moving mold protrudes a small distance beyond the end surface of the mold holder facing the stationary mold to minimize flash produced by slanting due to off-center pressure on the molds.

### SUMMARY

The following summary is intended to introduce the reader to various aspects of the applicant's teaching, but not to define any invention. In general, disclosed herein are one or more methods or apparatuses related to injection molding, and to injecting melt into a mold half apparatus.

According to some aspects, an injection molding machine comprises: (a) a machine base extending lengthwise along a generally horizontal machine axis, the base having a platen support portion extending along a first axial portion of the base, and an injection unit support portion extending along a second axial portion of the base; (b) a platen supported by the platen support portion for carrying a mold half apparatus; (c) a first injection unit supported by the injection unit support portion, the first injection unit including a first barrel and a first nozzle assembly at a front end of the first barrel for discharging a first melt through the platen into a first mold inlet of the mold half apparatus; and (d) a second injection unit supported by the injection unit support portion, the second injection unit including a second barrel and a second nozzle assembly at a front end of the second barrel for discharging a second melt around the platen into a second mold inlet of the mold half apparatus.

In some examples, the first barrel extends lengthwise along the machine axis. In some examples, the second barrel extends lengthwise alongside the first barrel. In some examples, the second barrel is laterally offset from and generally parallel to the first barrel.

In some examples, the injection unit support portion has a base width bounded laterally by an axially extending first side at an operator side of the machine, and an axially extending second side at a non-operator side of the machine, the first and second barrels laterally intermediate the first side and the second side.

In some examples, the first and second barrels are at a generally common elevation.

In some examples, the platen includes a platen front face having a front face central portion for abutting the mold half apparatus, a platen rear face axially opposite the platen front face, a platen bottom surface directed toward the base, a platen top surface opposite the platen bottom surface, and a platen side surface extending vertically between the platen top and bottom surfaces and axially between the platen front and rear faces, and wherein the second nozzle assembly extends around the platen laterally outboard of the platen side surface.

In some examples, the platen front face includes a front face marginal portion laterally offset from the front face central portion, and wherein the second nozzle assembly includes a second barrel nozzle at a front end of the second barrel and a nozzle extension mounted to the front face marginal portion for conducting the second melt from the second barrel nozzle to the second mold inlet.

In some examples, the nozzle extension includes an extension inlet laterally outboard of the platen side surface of the platen for receiving the second melt from the second barrel nozzle.

In some examples, the nozzle extension includes an extension outlet laterally inboard of the platen side surface of the platen for discharging the second melt into the second mold inlet.

According to some aspects, an injection molding machine comprises: (a) a machine base extending lengthwise along a generally horizontal machine axis, the base having a platen support portion extending along a first axial portion of the base, and an injection unit support portion extending along a second axial portion of the base; (b) a platen supported by the platen support portion for carrying a mold half apparatus, the platen including a platen front face having a front face central portion for abutting the mold half apparatus and a front face marginal portion laterally offset from the front face central portion; (c) a first injection unit supported by the injection unit support portion, the first injection unit including a first barrel and a first barrel nozzle at the front end of the first barrel for discharging a first melt into a first mold inlet of the mold half apparatus; and (d) a second injection unit supported by the injection unit support portion, the second injection unit including a second barrel, a second barrel nozzle at the front end of the second barrel for discharging a second melt, and a nozzle extension mounted to the front face marginal portion of the platen for conducting the second melt from the second barrel nozzle to a second mold inlet of the mold half apparatus.

In some examples, the nozzle extension includes an extension inlet for receiving the second melt in an axial direction from the second barrel nozzle and an extension outlet for discharging the second melt in a lateral direction into the second mold inlet.

In some examples, the nozzle extension includes an extension body having an internal extension conduit extending between the extension inlet and the extension outlet for conducting the second melt from the extension inlet to the extension outlet.

In some examples, the extension conduit includes a curved portion for directing the second melt from the axial direction to the lateral direction. In some examples, the curved portion extends along a curved portion centerline between a curved portion inlet directed axially toward the extension inlet and a curved portion outlet directed laterally toward the extension outlet. In some examples, the extension conduit includes an axial portion extending axially from the extension inlet to the curved portion inlet and a lateral portion extending laterally from the curved portion outlet to the extension outlet. In some examples, the extension conduit has a generally circular cross-section along at least the curved portion, and the curved portion centerline has a radius of curvature greater than a cross-sectional diameter of the conduit along the curved portion. In some examples, the radius of curvature is at least twice the diameter.

In some examples, the body includes an extension inlet engagement surface circumscribing the extension inlet, the extension inlet engagement surface directed axially rearward toward the second barrel nozzle for engagement by the second barrel nozzle.

In some examples, the body includes an extension outlet engagement surface circumscribing the extension outlet, the extension outlet engagement surface directed laterally inward for engagement with a second mold inlet engagement surface circumscribing the second mold inlet.

In some examples, the nozzle extension includes a housing fixed to the front face marginal portion, the body mounted within and laterally slidable relative to the housing.

In some examples, the nozzle extension includes a pushing device coupled to the housing and disposed laterally outward of the body, the pushing device exerting a laterally inwardly directed force on the body to hold the extension outlet engagement surface in engagement with the second mold inlet engagement surface during injection of the second melt into the second mold inlet. In some examples, a magnitude of the laterally inwardly directed force is adjustable.

In some examples, the pushing device comprises a compression spring for pushing the body laterally inward, the spring laterally compressed between a first abutment surface locked relative to the housing and a second abutment surface fixed relative to the body during injection of the second melt. In some examples, a preload on the spring is adjustable. In some examples, the first abutment surface is locked at a lateral location relative to the housing, the lateral location adjustable for adjusting the preload on the spring.

In some examples, the housing includes a housing sidewall laterally outward of the body and an internally threaded bore extending laterally through the sidewall, and the pushing device includes an endcap having a threaded outer surface in threaded engagement with the internally threaded bore, and wherein the first abutment surface is fixed to the endcap and the endcap is rotatable relative to the housing sidewall for adjusting the lateral location of the first abutment surface.

In some examples, the body is supported within the housing on a plurality of contact pads fixed to inner surfaces of the housing, the contact pads inhibiting axial and vertical movement of the body and accommodating lateral movement of the body.

In some examples, the contact pads inhibit heat transfer between the body and the housing.

In some examples, the contact pads space apart outer surfaces of the body from the inner surfaces of the housing to inhibit heat transfer between the body and the housing.

In some examples, the contact pads are formed of thermally insulative material for inhibiting heat transfer between the body and the housing.

According to some aspects, an injection molding machine comprises: (a) a machine base; (b) a platen supported on the machine base for carrying a mold half apparatus, the platen including a platen front face having a front face central portion for abutting the mold half apparatus, and a front face marginal portion laterally offset from the front face central portion; and (c) a nozzle extension mounted to the front face marginal portion, the nozzle extension including an extension inlet for receiving a mold material in an axial direction from a barrel nozzle of an injection unit, and an extension outlet for discharging the mold material in a lateral direction into a mold inlet of the mold half apparatus.

According to some aspects, a method of operating an injection molding machine comprises: (a) discharging a first melt in an axial direction into a first mold inlet of a first mold half apparatus, the first mold half apparatus mounted to a front face central portion of a platen; (b) discharging a second melt in an axial direction into a nozzle extension, the nozzle extension mounted to a front face marginal portion of the platen, the front face marginal portion laterally offset from the front face central portion; and (c) discharging the second melt from the nozzle extension in a lateral direction into a second mold inlet of the first mold half apparatus.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is an elevation view of an injection molding machine;

FIG. 2 is a plan view of the machine of FIG. 1;

FIG. 3 is a front perspective view taken from the non-operator side of the machine of FIG. 1;

FIG. 4 is a rear perspective view taken from the non-operator side of the machine of FIG. 1;

FIG. 5 is an enlarged view of a portion of FIG. 3;

FIG. 6 is an enlarged view of a portion of FIG. 4;

FIG. 7 is a cross-sectional view of a portion of the machine of FIG. 1, taken along line 7-7 of FIG. 5;

FIG. 7a is an enlarged view of a portion of FIG. 7;

FIG. 8 is a cross-sectional view of a portion of the machine of FIG. 1, taken along line 8-8 of FIG. 6;

FIG. 9 is a cross-sectional view of a portion of the machine of FIG. 1, taken along line 9-9 of FIG. 5; and

FIG. 10 is a cross-sectional view of a portion of an alternative injection molding machine.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

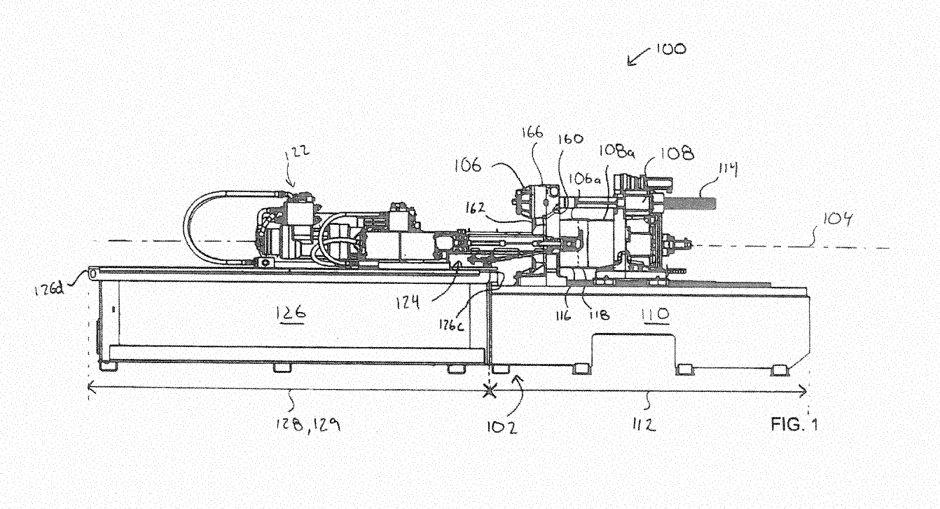

Referring to FIG. 1, an example of an injection molding machine 100 includes a base 102 that extends lengthwise along a generally horizontal machine axis 104. A pair of platens, including a first platen 106 and a second platen 108, are supported by the machine base 102 for carrying respective first and second mold half apparatuses 106a, 108a of a mold. In the example shown, the first platen 106 and the second platen 108 are supported by a platen support portion 110 of the machine base 102. The platen support portion 110 extends along a first axial portion 112 of the base 102. A plurality of tie bars 114 extend between the first and second platens 106, 108 for coupling the platens together and exerting a clamp load across the platens when stretched.

In the example illustrated, the first platen 106 is also referred to as a stationary platen, and the second platen 108 is also referred to as a moving platen. The second (moving) platen 108 can translate towards and away from the first (stationary) platen 106 along the machine axis 104 to close and open the mold.

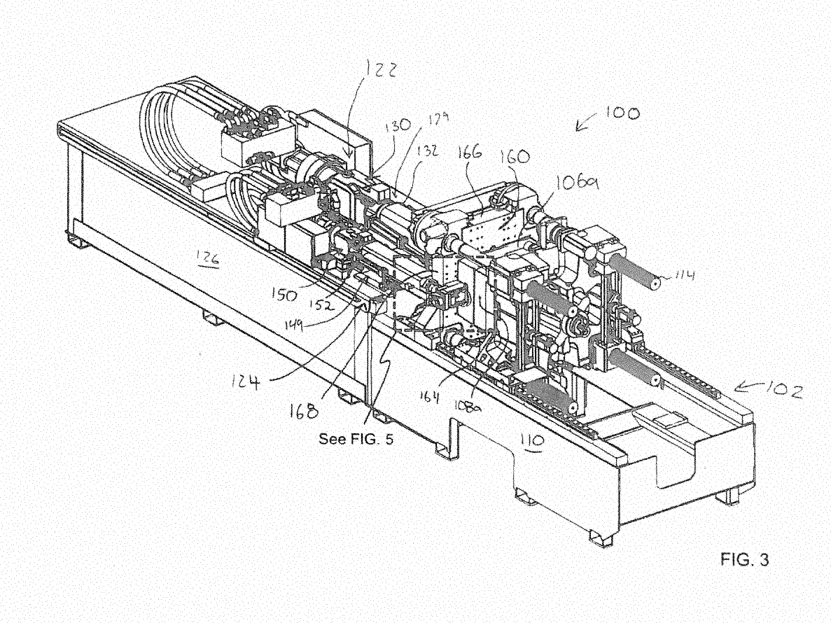

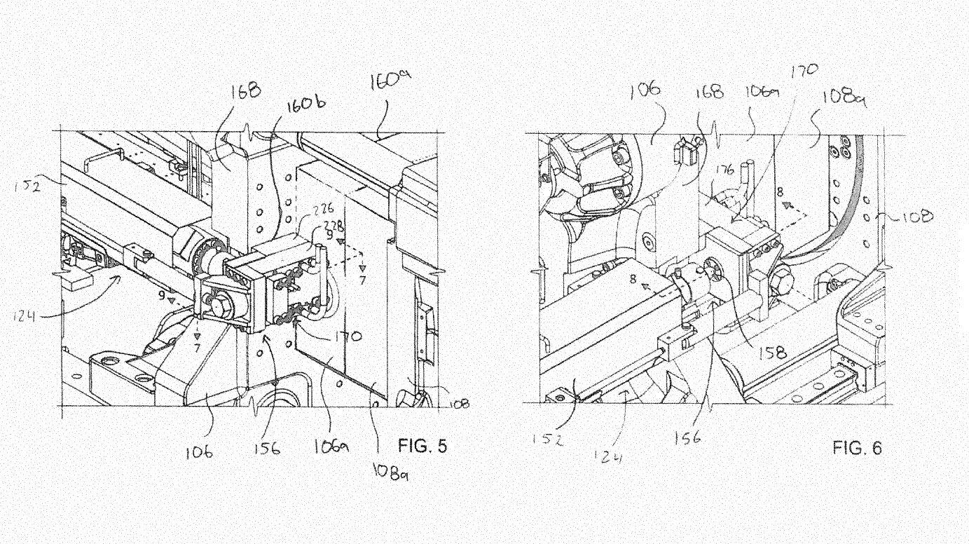

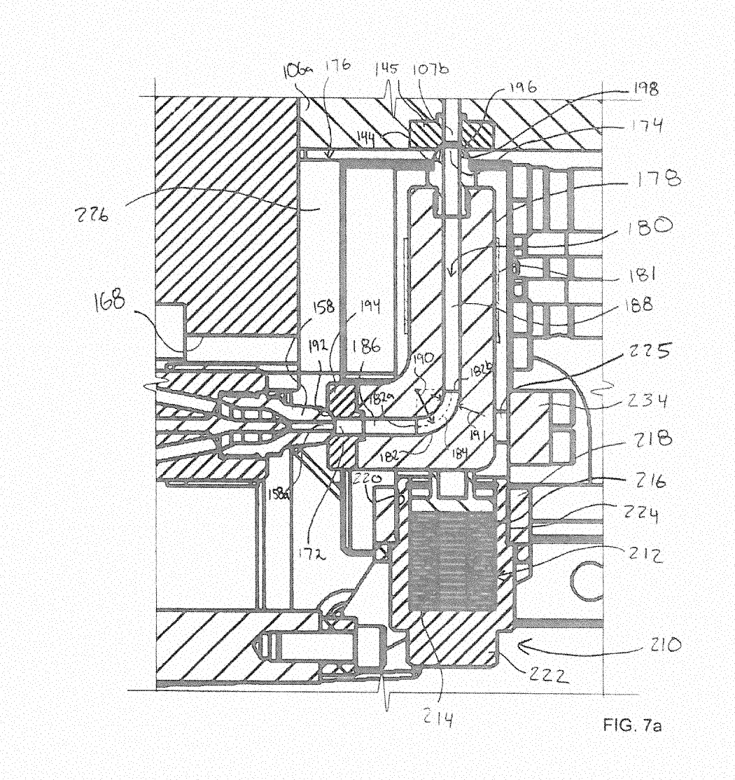

In the example illustrated, the first platen 106 includes a platen front face 160 having a front face central portion 160a (FIG. 5) for abutting the first mold half apparatus 106a, and a platen rear face 162 axially opposite the platen front face 160. A sprue hole 140 (FIG. 7) is centrally located on the front face central portion 160a, and extends axially between the front face central portion 160a and the platen rear face 162. The machine axis 104 passes through a center of the sprue hole 140 in the example illustrated. The first platen 106 further includes a platen bottom surface 164 (FIG. 3) directed toward the base 102, a platen top surface 166 opposite the platen bottom surface 164, and a platen side surface 168 extending vertically between the platen bottom and top surfaces 164, 166 and axially between the platen front and rear faces 160, 162. The first platen 106 has two side surfaces, one on the operator side of the machine 100 and the other on the non-operator side of the machine 100. In the example illustrated, the side surface 168 is the side surface on the non-operator side of the machine 100.

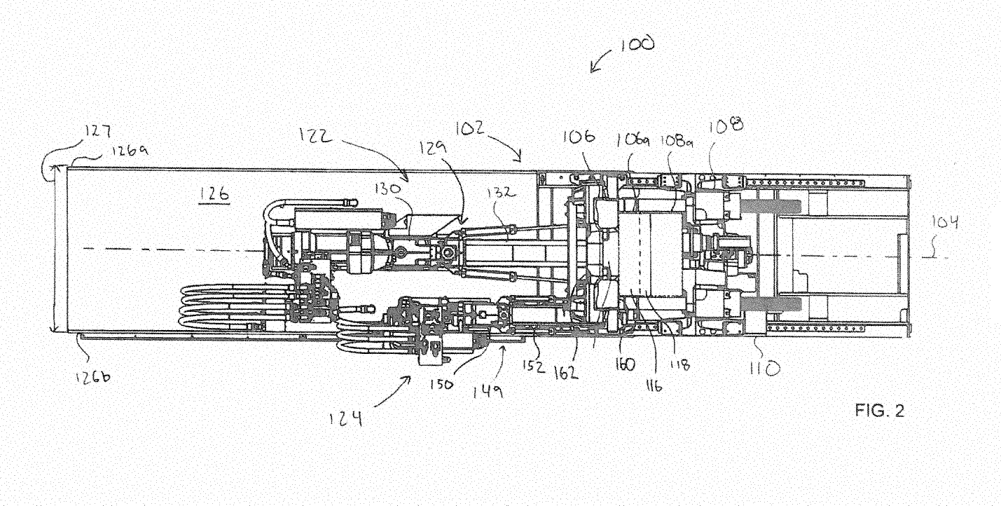

Referring to FIG. 2, in the example illustrated, the injection molding machine 100 includes a first injection unit 122 and a second injection unit 124 supported by the base 102. In the example shown, the first and second injection units 122, 124 are supported by an injection unit support portion 126 of the base 102. The injection unit support portion 126 extends along a second axial portion 128 of the base 102.

In the example illustrated, the first injection unit 122 can inject a first melt into the first mold half apparatus 106a, and the second injection unit 124 can inject a second melt into the first mold half apparatus 106a. The first and second melts can have different properties such as, for example, different compositions or different colors. In some examples, the first melt and the second melt can be the same.

Referring to FIG. 7, in the example illustrated, the first mold half apparatus 106a includes a first mold inlet 107a for receiving the first melt from the first injection unit 122, and a second mold inlet 107b for receiving the second melt from the second injection unit 124. In the example illustrated, the first mold half apparatus 106a includes a hot runner apparatus 116 mounted to the front face central portion 160a of the first platen 106a, and a mold cavity half 118 (FIG. 1) attached to the hot runner apparatus 116. The first mold inlet 107a is in fluid communication with a first melt passage 116a (shown schematically in FIG. 7) of the hot runner apparatus 116 for conducting the first melt to cavities of the mold. The second mold inlet 107b is in fluid communication with a second melt passage 116b (shown schematically in FIG. 7) of the hot runner apparatus 116 for conducting the second melt to cavities of the mold.

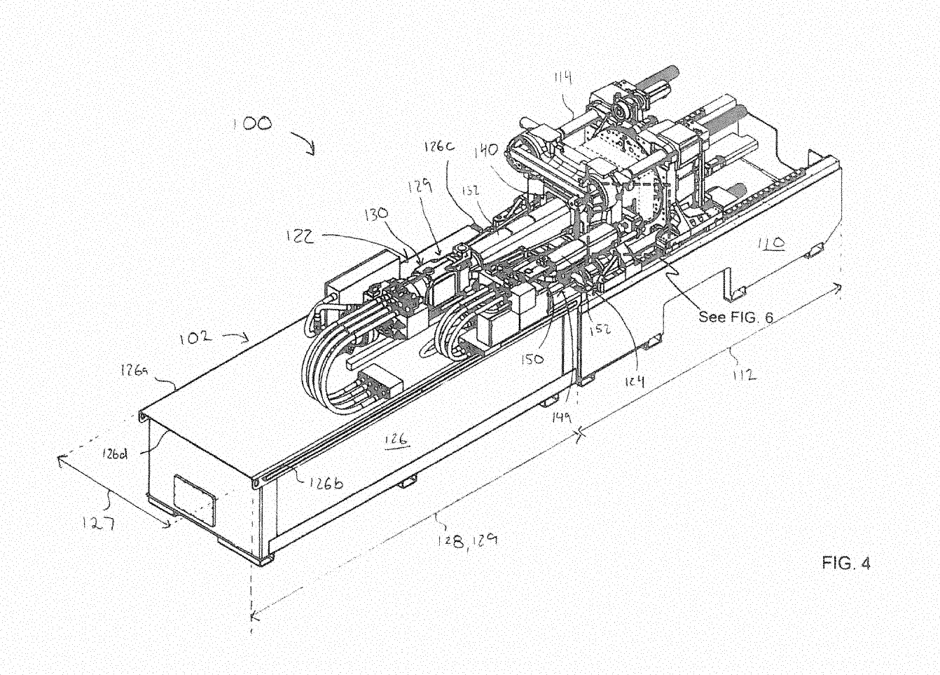

Referring to FIG. 4, in the example illustrated, the first injection unit 122 includes a first barrel assembly 129 having a first drive 130 and a first barrel 132 extending from the first drive 130 towards the first platen 106. In the example illustrated, the first barrel 132 extends lengthwise along the machine axis 104 during injection of the first melt. The first barrel 132 extends generally parallel to the machine axis 104 in the example illustrated. A first injection screw 134 (FIG. 7) is housed within the first barrel 132.

Referring to FIG. 7, in the example illustrated, the first injection unit 122 further includes a first nozzle assembly 136 at a front end of the first barrel 132 for discharging the first melt through the first platen 106 into the first mold inlet 107a. The first nozzle assembly 136 comprises a first barrel nozzle 138 at the front end of the first barrel 132. The first barrel nozzle 138 includes an axially extending first barrel nozzle conduit 138a for discharging the first melt in an axial direction into the first mold inlet 107a. The axial direction is generally parallel to the machine axis 104.

In the example illustrated, the first barrel assembly 129 is slidably mounted on the base 102. The first barrel assembly 129 is slidable parallel to the machine axis 104 between a first advanced position and a first retracted position for advancing and retracting the first barrel nozzle 138 relative to the first platen 106. Referring to FIG. 7, in the example illustrated, when the first barrel assembly 129 is in the first advanced position, the first barrel nozzle 138 extends through the sprue hole 140 for engagement with a first mold inlet engagement surface 142 circumscribing the first mold inlet 107a. In the example illustrated, the first mold half apparatus 106a includes a first sprue bushing 143 comprising the first mold inlet 107a and the first mold inlet engagement surface 142. When the first barrel nozzle 138 is in engagement with the first mold inlet engagement surface 142, the first melt can be discharged from the first barrel nozzle 138 into the first mold inlet 107a. When the first barrel assembly 129 is in the first retracted position, the first barrel nozzle 138 is spaced axially apart from the first mold inlet engagement surface 142.

Optionally, the first barrel assembly 129 can be pivotable relative to the base 102 about a generally vertical first pivot axis. In the example illustrated, the first drive 130 is pivotable about the first pivot axis between a first injection position, in which the first barrel 132 extends generally parallel with the machine axis 104, and a first service position, in which the front end of the first barrel assembly 129 is swung out toward a first side 126a of the injection molding machine 100. This can help facilitate inspection and maintenance of the first injection unit 122.

Referring to FIG. 2, in the example illustrated, the second injection unit 124 includes a second barrel assembly 149 having a second drive 150 and a second barrel 152 extending from the second drive 150 towards the first platen 106. In the example illustrated, a second injection screw 154 (FIG. 7) is housed within the second barrel 152. The second barrel 152 extends lengthwise alongside the first barrel 132. In the example illustrated, the second barrel 152 is laterally offset from and extends lengthwise generally parallel to the first barrel 132.

In the example illustrated, the injection unit support portion 126 has a base width 127 bounded laterally by an axially extending first side 126a and an axially extending second side 126b of the injection unit support portion 126. The first side 126a is at the operator side of the machine 100 and the second side 126b is at the non-operator side of the machine 100. In the example illustrated, the first and second barrels 132, 152 are generally laterally intermediate the first side 126a and the second side 126b of the injection unit support portion 126. The first barrel 132 is laterally centered between the first side 126a and the second side 126b in the example illustrated. The second barrel 152 is laterally offset from the first barrel 132 toward the second side 126b of the injection unit support portion 126 in the example illustrated.

Referring to FIG. 4, in the example illustrated, the injection unit support portion 126 has a length 129 bounded axially by a laterally extending front end 126c adjacent the platen support portion 110, and a laterally extending rear end 126d spaced apart from the front end 126c. In the example illustrated, the first and second drives 130, 150 are generally axially intermediate the front end 126c and the rear end 126d of the injection unit support portion 126. The first and second barrels 132, 152 are at a generally common elevation in the example illustrated.

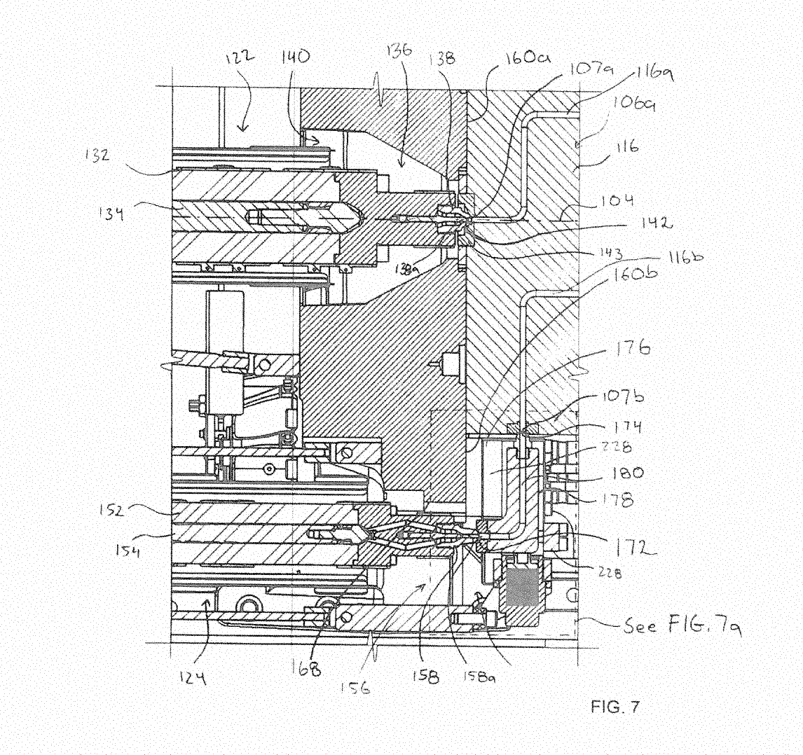

Referring to FIGS. 5 and 6, the second injection unit 124 includes a second nozzle assembly 156 at a front end of the second barrel 152 for discharging the second melt around the first platen 106 into the second mold inlet 107b of the first mold half apparatus 106a. In the example illustrated, the second melt is discharged from the second nozzle assembly 156 into the second mold inlet 107b in a lateral direction. The lateral direction is generally horizontal and perpendicular to the machine axis 104. In the example illustrated, the second nozzle assembly 156 extends around the first platen 106 laterally outboard of the platen side surface 168.

Referring to FIG. 5, the platen front face 160 includes a front face marginal portion 160b laterally offset from the front face central portion 160a. The front face central portion 160a and the front face marginal portion 160b are aligned in a common vertical plane in the example illustrated. Referring to FIG. 6, the second nozzle assembly 156 includes a second barrel nozzle 158 at a front end of the second barrel 152, and a nozzle extension 170 mounted to the front face marginal portion 160b for conducting the second melt from the second barrel nozzle 158 to the second mold inlet 107b. Referring to FIG. 7, the nozzle extension 170 includes an extension inlet 172 for receiving the second melt from the second barrel nozzle 158, and an extension outlet 174 for discharging the second melt into the second mold inlet 107b. The second melt is discharged from the extension outlet 174 in the lateral direction.

In the example illustrated, the second barrel nozzle 158 and the extension inlet 172 are laterally outboard of the platen side surface 168. The second barrel nozzle 158 includes an axially extending second barrel nozzle conduit 158a for discharging the second melt in the axial direction into the extension inlet 172. The extension outlet 174 is laterally inboard of the platen side surface 168, and is axially forward of the front face marginal portion 160b.

Referring to FIG. 7a, in the example illustrated, the nozzle extension 170 includes an extension housing 176 fixed to the front face marginal portion 160b, and an extension body 178 supported within the housing 176. The body 178 includes an internal extension conduit 180 extending between the extension inlet 172 and the extension outlet 174 for conducting the second melt from the extension inlet 172 to the extension outlet 174. A heating element 181 is coupled to the body 178 for heating the second melt conducted through the extension conduit 180 in the example illustrated.

In the example illustrated, the extension conduit 180 includes a curved portion 182 for directing the second melt from the axial direction to the lateral direction. The curved portion 182 extends along a curved portion centerline 184 between a curved portion inlet 182a directed axially toward the extension inlet 172 and a curved portion outlet 182b directed laterally toward the extension outlet 174. In the example illustrated, the extension conduit 180 includes a conduit axial portion 186 extending axially from the extension inlet 172 to the curved portion inlet 182a, and a conduit lateral portion 188 extending laterally from the curved portion outlet 182b to the extension outlet 174.

The extension conduit 180 can have a generally circular cross section along at least the curved portion 182. In the example illustrated, the extension conduit 180 has a generally circular cross section along an entire length of the conduit 180. The curved portion centerline 184 has a radius of curvature 190 greater than a cross-sectional diameter 191 of the extension conduit along the curved portion 182. The radius of curvature 190 can be at least twice the diameter 191. In the example illustrated, the radius of curvature 190 is approximately twice the diameter 191. This can help reduce inertial resistance of the second melt conducted through the conduit 180.

In the example illustrated, the body 178 includes an extension inlet engagement surface 192 circumscribing the extension inlet 172. The extension inlet engagement surface 192 is directed axially rearward toward the second barrel nozzle 158 for engagement by the second barrel nozzle 158. In the example illustrated, the body 178 includes an extension inlet bushing 194 comprising the extension inlet 172 and the extension inlet engagement surface 192.

In the example illustrated, the second barrel assembly 149 is slidably mounted on the base 102. The second barrel assembly is slidable parallel to the machine axis 104 between a second advanced position and a second retracted position for advancing and retracting the second barrel nozzle 158 relative to the nozzle extension 170. Referring to FIG. 7a, when the second barrel assembly 149 is in the second advanced position, the second barrel nozzle 158 extends laterally outboard of the platen side surface 168, and is in engagement with the extension inlet engagement surface 192 for discharging the second melt into the extension inlet 172. When the second barrel assembly 149 is in the retracted position, the second barrel nozzle 158 is spaced axially apart from the extension inlet engagement surface 192.

Optionally, the second barrel assembly 149 can be pivotable relative to the base 102 about a generally vertical second pivot axis. In the example illustrated, the second barrel assembly 149 is pivotable about the second pivot axis between a second injection position, in which the second barrel 152 extends lengthwise generally parallel with the machine axis 104, and a second service position, in which a front end of the second barrel 152 is swung out toward the second side 126b of the machine 100. This may help facilitate inspection and maintenance of the second injection unit 124. This may also help maintain lateral alignment between the second barrel nozzle 158 and the extension inlet 172 in cases where the extension inlet 172 is laterally displaced, for example, due to thermal expansion or contraction of the body 178.

Referring to FIG. 7a, in the example illustrated, the body 178 includes an extension outlet engagement surface 196 circumscribing the extension outlet 174. The extension outlet engagement surface 196 is directed laterally inward toward the machine axis 104 for engagement with a second mold inlet engagement surface 144 circumscribing the second mold inlet 107b. In the example illustrated, the body 178 includes an extension outlet nozzle 198 comprising the extension outlet 174 and the extension outlet engagement surface 196. The first mold half apparatus 106a includes a second sprue bushing 145 comprising the second mold inlet 107b and the second mold inlet engagement surface 144.

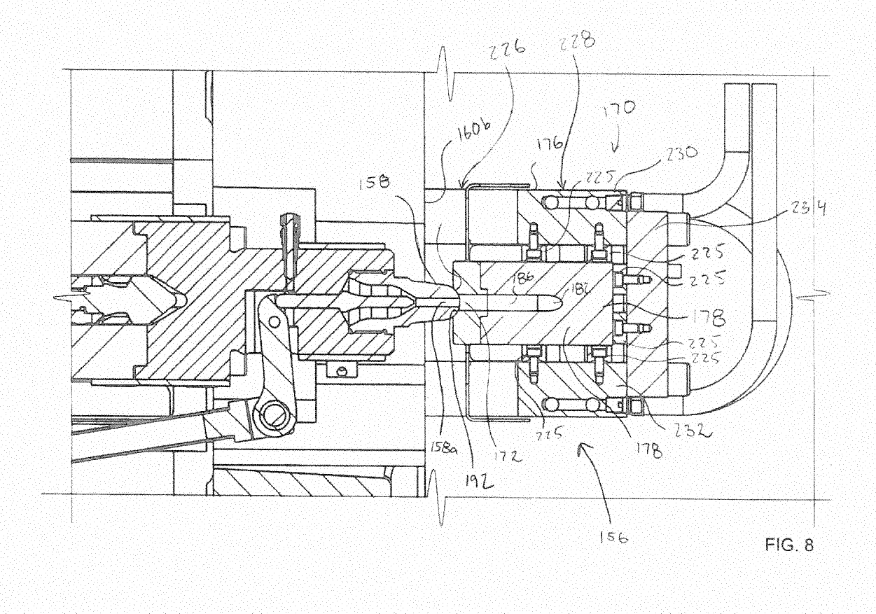

Referring to FIG. 8, in the example illustrated, the body 178 is laterally slidable relative to the housing 176. A pushing device 210 is coupled to the housing 176, and disposed laterally outward of the body 178. The pushing device 210 exerts a laterally inwardly directed force on the body 178 to hold the extension outlet engagement surface 196 in engagement with the second mold inlet engagement surface 144 during injection of the second melt into the second mold inlet 107b. The pushing device 210 can yield to lateral movement of the body 178 resulting from, for example, thermal expansion of the body 178.

The magnitude of the laterally inwardly directed force is adjustable in the example illustrated. In the example illustrated, the pushing device 210 comprises a compression spring 212 for exerting the laterally inwardly directed force on the body 178 to push the body 178 laterally inward. The spring 212 comprises a plurality of laterally stacked coned-disc springs in the example illustrated. The spring 212 is laterally compressed between a first abutment surface 214 locked relative to the housing 176 and a second abutment surface 216 locked relative to the body 178 during injection of the second melt. The preload on the spring 212 is adjustable. In the example illustrated, the first abutment surface 214 is locked at a lateral location relative to the housing 176. The lateral location is adjustable for adjusting the preload on the spring 212.

In the example illustrated, the housing 176 includes a housing sidewall 218 laterally outward of the body 178, and an internally threaded bore 220 extending laterally through the housing sidewall 218. The pushing device 210 includes an endcap 222 having a threaded outer surface 224 in threaded engagement with the internally threaded bore 220. The first abutment surface 214 is fixed to the endcap 222. In the example illustrated, the endcap 222 is rotatable relative to the housing sidewall 218 for adjusting the lateral location of the first abutment surface 214.

In the example illustrated, the body 178 is supported within the housing 200 on a plurality of contact pads 225 fixed to inner surfaces of the housing 200. The contact pads 225 inhibit axially forward and vertical movement of the body 178, and accommodate lateral movement of the body 178. The contact pads 225 inhibit heat transfer between the body 178 and the housing 200. In the example illustrated, the contact pads 225 space apart outer surfaces of the body 178 from inner surfaces of the housing 200 to inhibit heat transfer between the body 178 and the housing 200. In the example illustrated, the contact pads 225 are formed of thermally insulative material for inhibiting heat transfer between the body and the housing.

In the example illustrated, the housing 200 includes a housing spacer portion 226 mounted against the front face marginal portion 160b, and a housing support portion 228 axially forward of and fixed to the housing spacer portion 226. The housing spacer portion 226 and the housing support portion 228 are bolted to the front face marginal portion 160b. In the example illustrated, the body 178 is supported within the housing support portion 228.

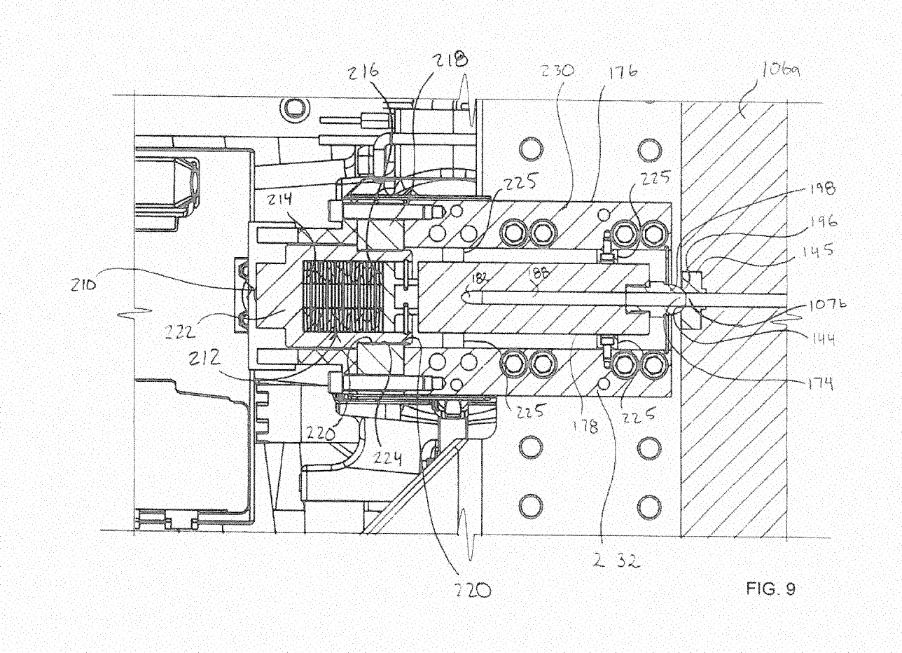

Referring to FIG. 8, in the example illustrated, the housing support portion 228 includes a housing top wall 230 above the body 178, an opposed housing bottom wall 232 below the body 178, a housing front wall 234 axially forward of the body 178 and extending vertically between the top wall 230 and the bottom wall 232, and the housing sidewall 218 (FIG. 9) laterally outward of the body 178 and extending vertically between the top wall 230 and the bottom wall 232. In the example illustrated, the contact pads 225 are fixed to and protrude inwardly toward the body 178 from inner surfaces of the housing top wall 230, the housing bottom wall 232, and the housing front wall 234.

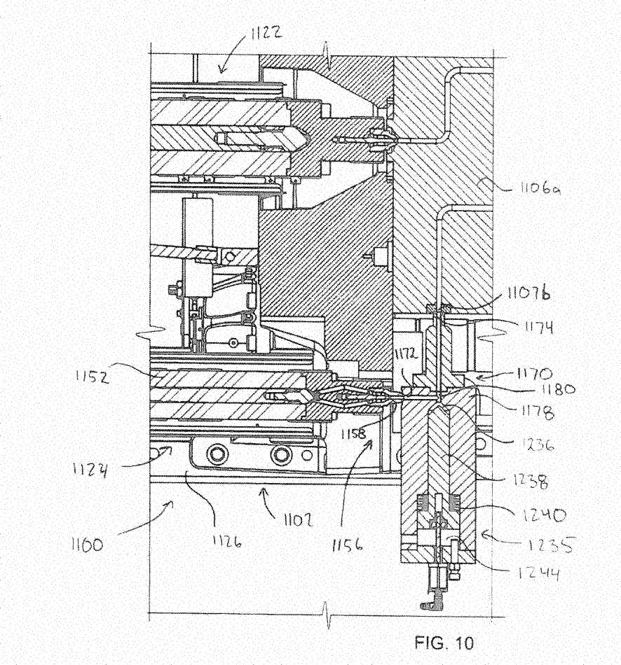

Referring to FIG. 10, an example of a portion of an alternative injection molding machine 1100 is illustrated. The machine 1100 has similarities to the machine 100, and like features are identified by like reference characters, incremented by 1000.

In the example illustrated, the machine 1100 includes a first injection unit 1122 and a second injection unit 1124 supported by an injection unit support portion 1126 of a machine base 1102. In the example illustrated, the second injection unit 1124 includes a second nozzle assembly 1156 at a front end of a second barrel 1152 for discharging the second melt around the platen 1106 into a second mold inlet 1107b of a first mold half apparatus 1106a. The second nozzle assembly 1156 includes a second barrel nozzle 1158 at a front end of the second barrel 1152, and a nozzle extension 1170 for conducting the second melt from the second barrel nozzle 1158 to the second mold inlet 1107b.

In the example illustrated, the nozzle extension 1170 includes an extension inlet 1172 for receiving the second melt from the second barrel nozzle 1158, and an extension outlet 1174 for discharging the second melt into the second mold inlet 1107b. The nozzle extension 1170 includes an extension body 1178 having an internal extension conduit 1180 extending between the extension inlet 1172 and the extension outlet 1174.

In the example illustrated, the body 1178 includes a plunger apparatus 1235 for discharging the second melt from the extension outlet 1174. The plunger apparatus 1235 includes a first chamber 1236 in fluid communication with the extension conduit 1180. The first chamber 1236 has an adjustable volume for receiving and dispensing the second melt. The first chamber 1236 is disposed laterally intermediate the extension outlet 1174 and an injection plunger 1238. The injection plunger 1238 is laterally slideable relative to the extension outlet 1174 between a plunger retracted and a plunger advanced position to increase and decrease, respectively, the volume of the first chamber 1236. The plunger 1238 is, in the example illustrated, pushed to the plunger retracted position as the first chamber 1236 receives the second melt, and is pushed to the plunger advanced position to dispense the melt. The plunger apparatus 1235 includes a spring 1240 for urging the plunger 1238 toward the plunger retracted position, and a second chamber 1244 for urging the plunger 1238 toward the plunger advanced position when pressurized.

1. An injection molding machine comprises:
a) a machine base extending lengthwise along a generally horizontal machine axis, the base having a platen support portion extending along a first axial portion of the base, and an injection unit support portion extending along a second axial portion of the base;
b) a platen supported by the platen support portion for carrying a mold half apparatus;
c) a first injection unit supported by the injection unit support portion, the first injection unit including a first barrel and a first nozzle assembly at a front end of the first barrel for discharging a first melt through the platen into a first mold inlet of the mold half apparatus; and
d) a second injection unit supported by the injection unit support portion, the second injection unit including a second barrel and a second nozzle assembly at a front end of the second barrel for discharging a second melt around the platen into a second mold inlet of the mold half apparatus;
wherein the first barrel extends lengthwise along the machine axis, wherein the second barrel extends lengthwise alongside the first barrel, and wherein the second barrel is laterally offset from and generally parallel to the first barrel.

2. The machine of claim 1, wherein the injection unit support portion has a base width bounded laterally by an axially extending first side at an operator side of the machine, and an axially extending second side at a non-operator side of the machine, the first and second barrels laterally intermediate the first side and the second side.

3. The machine of claim 1, wherein the first and second barrels are at a generally common elevation.

4. The machine of claim 1, wherein the platen includes a platen front face having a front face central portion for abutting the mold half apparatus, a platen rear face axially opposite the platen front face, a platen bottom surface directed toward the base, a platen top surface opposite the platen bottom surface, and a platen side surface extending vertically between the platen top and bottom surfaces and axially between the platen front and rear faces, and wherein the second nozzle assembly extends around the platen laterally outboard of the platen side surface.

5. The machine of claim 4, wherein the platen front face includes a front face marginal portion laterally offset from the front face central portion, and wherein the second nozzle assembly includes a second barrel nozzle at a front end of the second barrel and a nozzle extension mounted to the front face marginal portion for conducting the second melt from the second barrel nozzle to the second mold inlet.

6. The machine of claim 5, wherein the nozzle extension includes an extension inlet laterally outboard of the platen side surface of the platen for receiving the second melt from the second barrel nozzle.

7. The machine of claim 5, wherein the nozzle extension includes an extension outlet laterally inboard of the platen side surface of the platen for discharging the second melt into the second mold inlet.

8. An injection molding machine comprising:
a) a machine base extending lengthwise along a generally horizontal machine axis, the base having a platen support portion extending along a first axial portion of the base, and an injection unit support portion extending along a second axial portion of the base;
b) a platen supported by the platen support portion for carrying a mold half apparatus, the platen including a platen front face having a front face central portion for abutting the mold half apparatus and a front face marginal portion laterally offset from the front face central portion;
c) a first injection unit supported by the injection unit support portion, the first injection unit including a first barrel and a first barrel nozzle at the front end of the first barrel for discharging a first melt into a first mold inlet of the mold half apparatus; and
d) a second injection unit supported by the injection unit support portion, the second injection unit including a second barrel, a second barrel nozzle at the front end of the second barrel for discharging a second melt, and a nozzle extension mounted to the front face marginal portion of the platen for conducting the second melt from the second barrel nozzle to a second mold inlet of the mold half apparatus.

9. The machine of claim 8, wherein the nozzle extension includes an extension inlet for receiving the second melt in an axial direction from the second barrel nozzle and an extension outlet for discharging the second melt in a lateral direction into the second mold inlet.

10. The machine of claim 9, wherein the nozzle extension includes an extension body having an internal extension conduit extending between the extension inlet and the extension outlet for conducting the second melt from the extension inlet to the extension outlet.

11. The machine of claim 10, wherein the extension conduit includes a curved portion for directing the second melt from the axial direction to the lateral direction.

12. The machine of claim 10, wherein the extension body includes an extension inlet engagement surface circumscribing the extension inlet, the extension inlet engagement surface directed axially rearward toward the second barrel nozzle for engagement by the second barrel nozzle.

13. The machine of claim 10, wherein the extension body includes an extension outlet engagement surface circumscribing the extension outlet, the extension outlet engagement surface directed laterally inward for engagement with a second mold inlet engagement surface circumscribing the second mold inlet.

14. The machine of claim 13, wherein the nozzle extension includes a housing fixed to the front face marginal portion, the extension body mounted within and laterally slidable relative to the housing.

15. The machine of claim 14, wherein the nozzle extension includes a pushing device coupled to the housing and disposed laterally outward of the body, the pushing device exerting a laterally inwardly directed force on the body to hold the extension outlet engagement surface in engagement with the second mold inlet engagement surface during injection of the second melt into the second mold inlet.

16. The machine of claim 15, wherein a magnitude of the laterally inwardly directed force is adjustable.

17. The machine of claim 16, wherein the pushing device comprises a compression spring for pushing the body laterally inward, the spring laterally compressed between a first abutment surface locked relative to the housing and a second abutment surface fixed relative to the body during injection of the second melt.

18. The machine of claim 17, wherein the housing includes a housing sidewall laterally outward of the body and an internally threaded bore extending laterally through the sidewall, and the pushing device includes an endcap having a threaded outer surface in threaded engagement with the internally threaded bore, and wherein the first abutment surface is fixed to the endcap and the endcap is rotatable relative to the housing sidewall for adjusting the lateral location of the first abutment surface to adjust a preload on the spring.

19. The machine of any one of claims 15 to 18, wherein the body is supported within the housing on a plurality of contact pads fixed to inner surfaces of the housing, the contact pads inhibiting axial and vertical movement of the body and accommodating lateral movement of the body.

20. A method of operating an injection molding machine, the method comprising:
a) discharging a first melt in an axial direction into a first mold inlet of a first mold half apparatus, the first mold half apparatus mounted to a front face central portion of a platen;
b) discharging a second melt in an axial direction into a nozzle extension, the nozzle extension mounted to a front face marginal portion of the platen, the front face marginal portion laterally offset from the front face central portion; and
c) discharging the second melt from the nozzle extension in a lateral direction into a second mold inlet of the first mold half apparatus.
